(19) United States
(12) Patent Application Publication
(10) Pub. No.: US 2024/0378533 A1
(43) Pub. Date: Nov. 14, 2024

(54) Management Method of safety Assessment Work in Buildings, and Worker's Terminal Being Installed with Program for Executing the Method

(71) Applicant: Hanstyle Engineering Co., Ltd., Seoul (KR)

(72) Inventor: Da Woon JEONG, Seoul (KR)

(21) Appl. No.: 18/389,796

(22) Filed: Dec. 20, 2023

(30) Foreign Application Priority Data
May 9, 2023 (KR) 10-2023-0059998

(51) Int. Cl. G06Q 10/0635; G06V 10/764

(52) U.S. Cl. CPC G06Q 10/0635; G06V 10/764

(57) ABSTRACT

Provided is a method for managing a safety assessment work of a building and a worker terminal installed with a program for executing the method for managing a safety assessment work thereof. The method is implemented through processes which are performed by the worker terminal and include: receiving floor number information of a safety assessment target building; generating work regions for each floor for safety assessment collaboration between a plurality of workers based on the floor number information of the safety assessment target building; storing drawings for each floor of the safety assessment target building in the work regions for each floor; and uploading the work regions for each floor in which the drawings for each floor are stored to a management server. Accordingly, it is possible to attain an efficient safety assessment work, and automatically generate a safety assessment report including work results automatically collected from several workers.

### STATEMENT DESIGNATING GRACE PERIOD INVENTOR DISCLOSURES

Applicant informs that the subject matter of this design was disclosed by the inventor or joint inventor or by another who obtained the subject matter disclosed directly or indirectly from the inventor or joint inventor one year or less than before the effective filing date of a claimed invention which do not qualify as prior art under 35 USC 102 (b) (1) in the following website:

https://apps.apple.com/kr/app/%EC%9D%B4%EC%A7%80%EC%95%88%EC%A
0%84%EC%A7%84%EB%8B%A8/id6443862756.

### CROSS REFERENCE TO RELATED APPLICATIONS

This application claims the benefit of Korean Patent Application No. 10-2023-0059998 filed on May 9, 2023, the entirety of which is incorporated by reference herein.

### BACKGROUND OF THE INVENTION

### 1. Field of the Invention

The present invention relates to a method for managing a safety assessment work of a building and a worker terminal installed with a program for executing the method for managing a safety assessment work of a building, and more particularly, to a method for managing a safety assessment work of a building, in which photographed pictures and related work information may be stored in association with work icons that display worker's photographing position and photographing direction information on drawing images such as a plan view of each floor to attain an efficient safety assessment work, and a worker may check photographed pictures and related work information of other workers who perform safety assessment together in the same building through a worker terminal to attain the efficient safety assessment work, as well as a safety assessment report including work results automatically collected from several workers may be automatically generated, and a worker terminal installed with a program for executing the method for managing a safety assessment work of a building.

### 2. Description of the Related Art

Commonly, a worker who visits a safety assessment target building for performing a safety assessment due to aging of the building, such as an occurrence of cracks, moves around inside the building while holding plan views for each floor of the building and photographs inspection target areas such as an area where cracks have occurred in a wall.

As described above, the worker moves through each floor of the building, takes dozens of pictures, and then writes a building assessment report. During this process, in general, the worker separately marks photographing positions and photographing directions of the worker who took each picture on the plan views for each floor.

Meanwhile, during writing a building assessment report, in order to mark the photographing positions and photographing directions on the plan views for each floor, the worker should photograph the inspection target areas in advance while moving inside the building, and separately record the photographing positions and photographing directions for each picture. However, due to various on-site conditions at the diagnosis site, cases where it is difficult to take pictures and record accurately occur frequently.

In addition, when a plurality of workers perform such the building safety assessment together, it is difficult to mutually check the photographed pictures and work information of other workers, such that efficient safety assessment work is not attained, as well as when writing a safety assessment report subsequently, there is a problem that it is necessary to collect and organize the photographed pictures and work information of several workers one by one, which is inefficient.

### SUMMARY OF THE INVENTION

Therefore, it is an object of the present invention to provide a method for managing a safety assessment work of a building, in which photographed pictures and related work information may be stored in association with work icons that display worker's photographing position and photographing direction information on drawing images such as a plan view of each floor to attain an efficient safety assessment work, and a worker may check photographed pictures and related work information of other workers who perform safety assessment together in the same building through a worker terminal to attain the efficient safety assessment work, as well as a safety assessment report including work results automatically collected from several workers may be automatically generated, and a worker terminal installed with a program for executing the method for managing a safety assessment work of a building.

The problem to be solved by the present invention is not limited to the above-described problems, and may include other technical problems that can be clearly understood by those skilled in the art from the following description.

To achieve the above object, according to an aspect of the present invention, there is provided a method for managing a safety assessment work of a building, which includes: (a) receiving, by a worker terminal, floor number information of a safety assessment target building; (b) generating, by the worker terminal, work regions for each floor for safety assessment collaboration between a plurality of workers based on the floor number information of the safety assessment target building; and (c) individually storing, by the worker terminal, drawings for each floor of the safety assessment target building in the work regions for each floor.

Preferably, the method further includes (d) uploading, by the worker terminal, the work regions for each floor in which the drawings for each floor are stored to a management server.

In addition, the method further includes: (e) generating, by the worker terminal, work icons at positions selected by the worker on the drawings for each floor; and (f) activating, by the worker terminal, a camera module provided in the worker terminal when an indicating direction of the generated work icon is selected by the worker.

In addition, the method further includes (g) storing, by the worker terminal, photographed pictures of the camera module in association with the work icon.

In addition, the method further includes (h) receiving, by the worker terminal, classification information for the photographed pictures.

In addition, the method further includes (i) outputting, by the worker terminal, a request to input additional description information corresponding to the classification information.

In addition, the method further includes (j) storing, by the worker terminal, work information including the classification information and the additional description information in association with the work icon.

In addition, the method further includes (k) uploading, by the worker terminal, the drawings for each floor in which the work icons are generated to the management server.

In addition, the method further includes (1) transmitting, by the worker terminal, an invitation message for a collaborator of another worker who will perform the safety assessment together in the work regions for each floor to the management server.

In addition, the method further includes (m) receiving, by the worker terminal, setting information about work permissions of the collaborator.

In addition, the method further includes (n) receiving, by the worker terminal, the drawings for each floor from the management server updated as the work icon is additionally generated by the collaborator terminal.

In addition, the method further includes (o) receiving, by the worker terminal, filtering reference information for the work icons included in the updated drawings for each floor according to the work of the collaborator.

In addition, the method further includes (p) generating, by the worker terminal, a safety assessment report of the building based on the updated drawings for each floor.

Meanwhile, according to another aspect of the present invention, there is provided a worker terminal including a program installed therein for executing the method for managing a safety assessment work of a building.

According to the present invention, photographed pictures, which are taken by a worker while moving within spaces for each floor of the building for safety assessment, and related work information may be stored in association with work icons that display worker's photographing position and photographing direction information on the drawing images such as a plan view of each floor to attain the efficient safety assessment work.

In addition, according to the present invention, a worker may check photographed pictures and related work information of other workers who perform safety assessment together in the same building through a worker terminal to attain the efficient safety assessment work.

Further, according to the present invention, a safety assessment report including work results automatically collected from several workers may be automatically generated.

The effects of the present invention are not limited to the above-described effects, and may include other effects that can be clearly understood by those skilled in the art from the following description.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a procedure flowchart describing execution processes of a method for managing a safety assessment work of a building according to an embodiment of the present invention;

FIGS. 2 to 20 are diagrams illustrating screen statuses of a worker terminal at each execution stage of the method for managing a safety assessment work of a building according to an embodiment of the present invention; and

FIG. 21 is a schematic view illustrating a configuration of a building safety assessment and management system according to an embodiment of the present invention.

### DETAILED DESCRIPTION OF THE INVENTION

Hereinafter, the present invention will be described with reference to the accompanying drawings in detail. Referring to the drawings, like reference characters designate like or corresponding parts throughout the several views. In the embodiments of the present invention, the publicly known functions and configurations that are judged to make the purport of the present invention unnecessarily obscure will not be described.

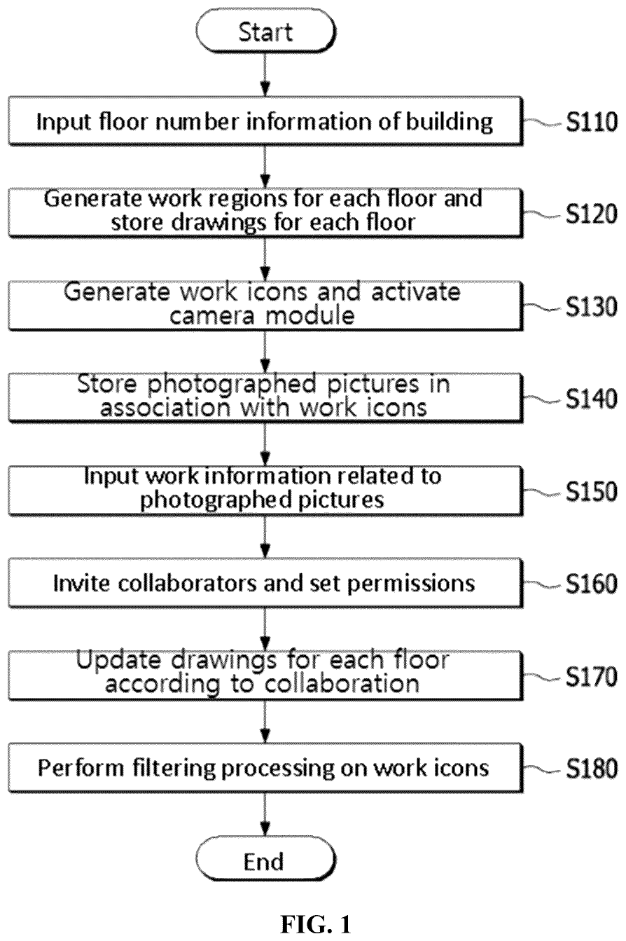

FIG. 1 is a procedure flowchart describing execution processes of a method for managing a safety assessment work of a building according to an embodiment of the present invention. Hereinafter, execution processes of the method for managing a safety assessment work of a building according to an embodiment of the present invention will be described with reference to FIG. 1.

Meanwhile, despite the definition of terms in related laws and regulations, the ‘safety diagnosis or assessment’ in the present disclosure is defined to include all management activities for a building, such as regular inspection and supervision of the building.

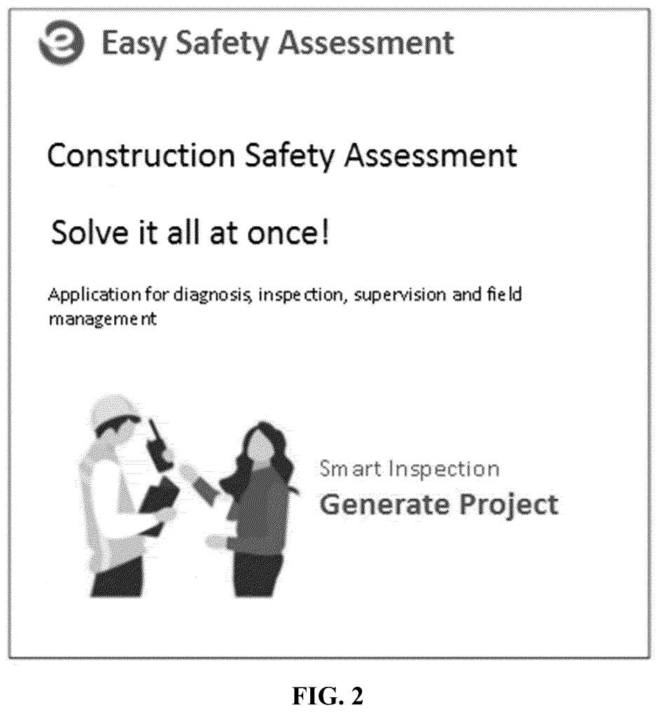

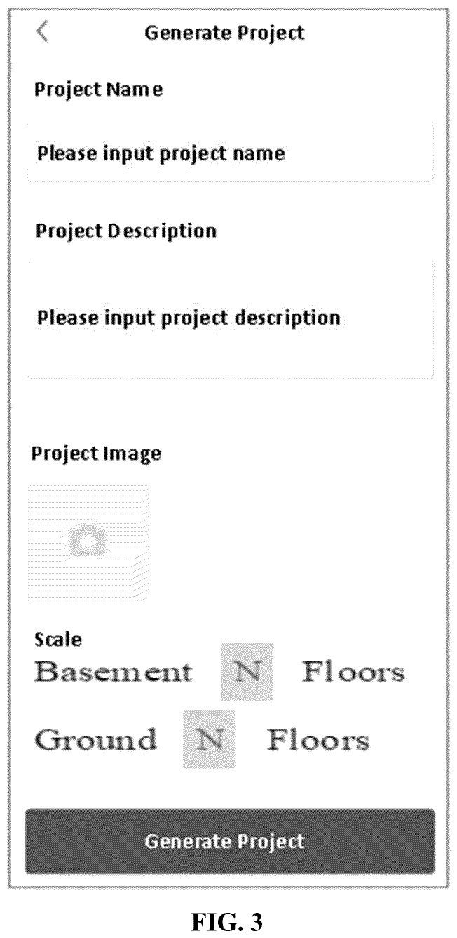

A worker who performs the safety assessment of a building and possesses a worker terminal 100, such as a smart phone, in which an application program for executing the method for managing a safety assessment work of a building according to the present invention is installed, may select ‘Generation Project’ on an execution screen of the application program as shown in FIG. 2, and then input project information such as a project name, project description, project image, information on the number of basement floors of the building (for example, two basement floors), and information on the number of ground floors (for example, five ground floors) as shown in FIG. 3 (S110).

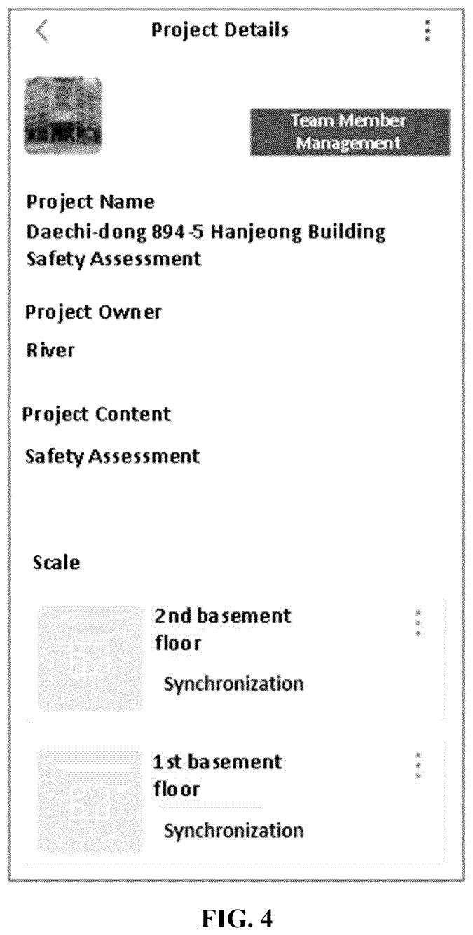

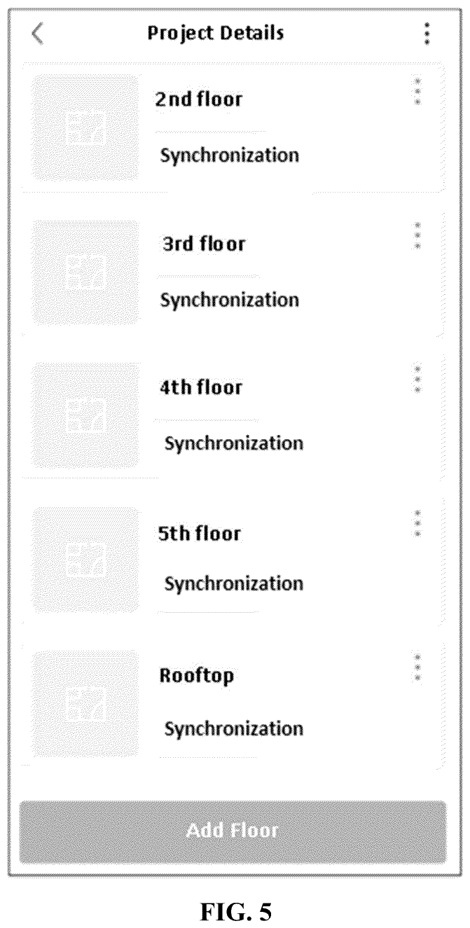

Thereby, the worker terminal 100 generates work regions for each floor for safety assessment collaboration between a plurality of workers based on the project information input by the worker as shown in FIGS. 4 and 5.

Meanwhile, in carrying out the present invention, when the worker selects an ‘Add Floor’ item and inputs a name of a floor to be added (for example, maisonette, rooftop floor) as shown in FIG. 5, the worker terminal 100 may also additionally generate a work region for the added floor.

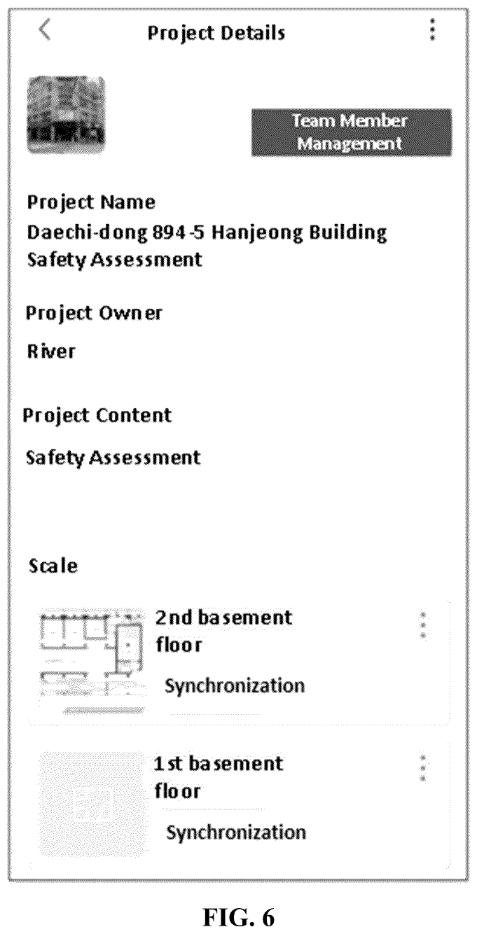

Thereafter, when the worker selects work regions for each floor shown in FIGS. 4 and 5, and then selects drawings for each floor, such as a plan view of the corresponding floor, which are already stored in the worker terminal 100, the worker terminal 100 stores the drawings for each floor of a safety assessment target building in the work regions for each floor in association therewith as shown in FIG. 6 (S120).

Meanwhile, when the worker selects a ‘Synchronization’ button displayed in the work regions for each floor, the work regions for each floor selected by the worker and the drawing images for each floor stored in association therewith may be uploaded to a management server 200.

As described above, the work regions for each floor and the drawing images for each floor stored in association therewith uploaded to the management server 200 may be downloaded to a terminal 300 of a collaborator (i.e., another worker) who has been given permission to participate in the project in the future, thus to support joint diagnostic work between the worker and collaborator on the corresponding floor.

In addition, according to the present invention, the worker may individually select ‘Synchronization’ in the work regions for each floor of the building, thereby individually determining whether to jointly perform the safety assessment work for each floor.

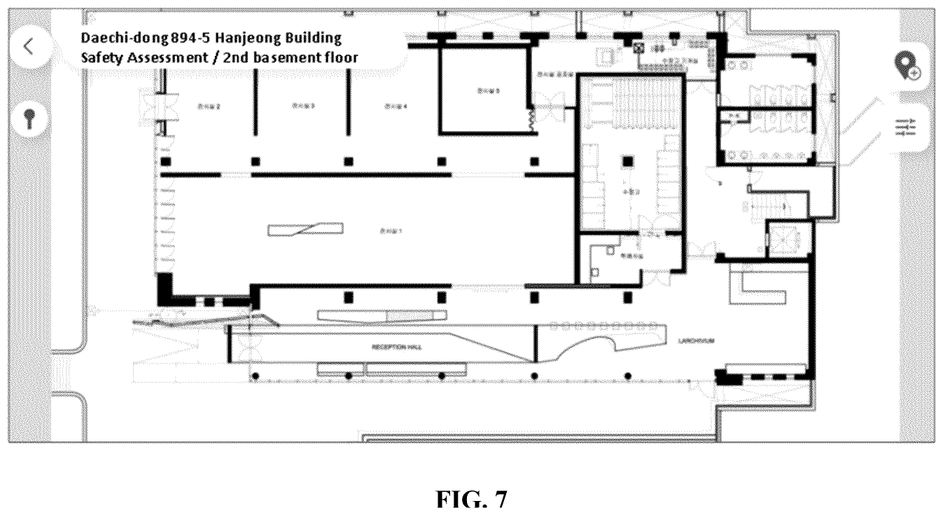

Meanwhile, when a worker who intends to perform a safety assessment on a specific floor (for example, the 2nd basement floor) of the safety assessment target building selects a drawing of the corresponding floor by touching on the screen of the worker terminal 100 shown in FIG. 6, the drawing of the corresponding floor may be output across the entire screen of the worker terminal 100 along with icon type information ( [symbol] ), an icon generation selection item ( [symbol] ), and an icon filtering selection item ( [symbol] ) as shown in FIG. 7.

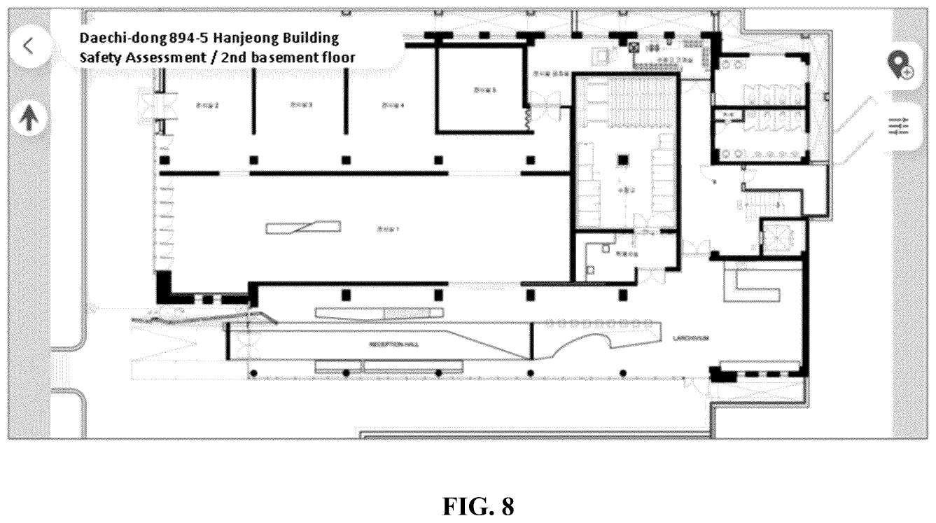

Accordingly, when the worker touches the icon type information ( [symbol] ) shown in FIG. 7, the icon type information is changed to an arrow shape ( [symbol] ) as shown in FIG. 8, thereby allowing the worker to select the type of work icon to be generated later.

Through this, the worker may select generation of a work icon which includes direction information in the form of an arrow, such as a gaze direction of the worker, or generation of a work icon which does not include the direction information.

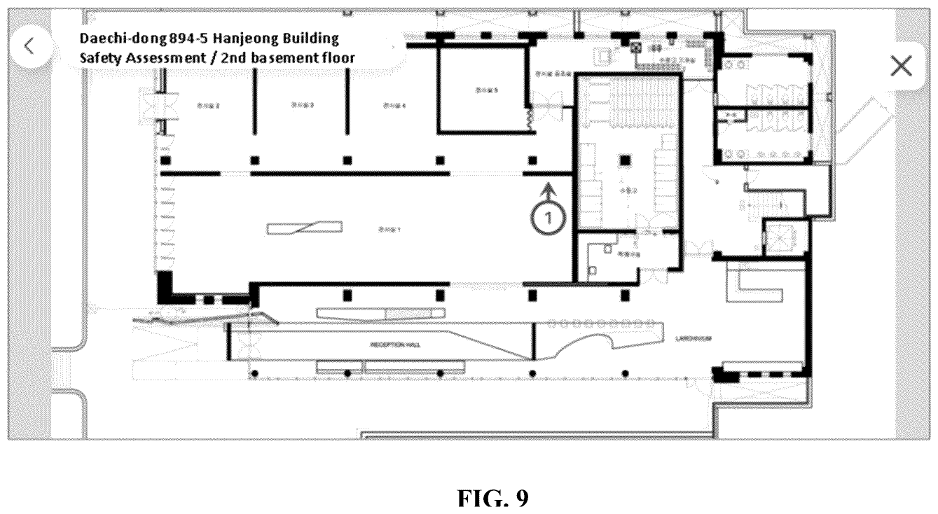

Thereafter, when the worker touches the icon generation selection item ( [symbol] ) shown in FIG. 8, and then selects by touching a current position of the worker, which is a position where the safety assessment is performed on the corresponding floor, on the drawing image shown in FIG. 8, the worker terminal 100 generates a work icon ( [symbol] ) at the corresponding position as shown in FIG. 9.

Specifically, as shown in FIG. 9, numeric information included in the generated work icon indicates an icon generation sequence (i.e., work sequence) on the corresponding floor, and color information of the work icon is identification information for identifying the corresponding worker among several workers who collaborate on the corresponding floor. Further, arrow direction (indicating direction) information in the work icon means information on a direction in which the worker is looking at for diagnosis (i.e., the photographing direction of the worker terminal).

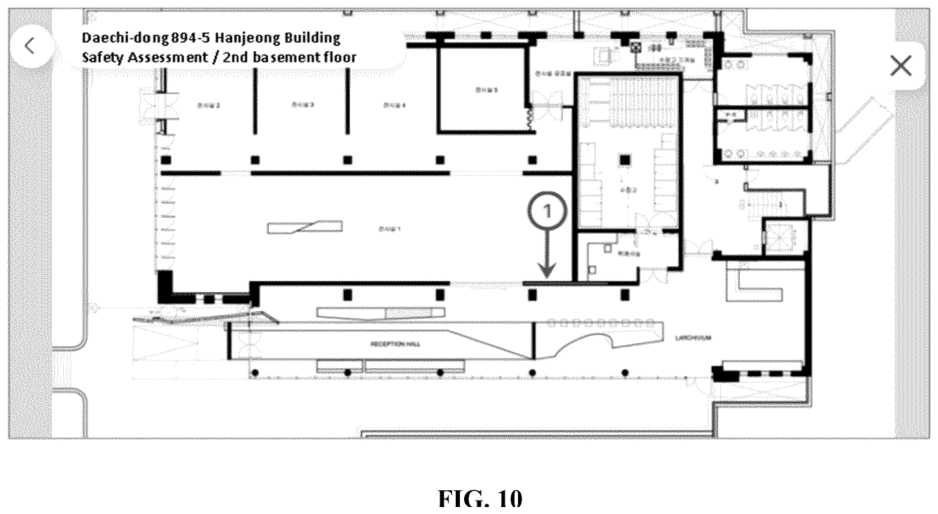

Meanwhile, the worker then touches the work icon shown in FIG. 9 and drag it in a clockwise or counterclockwise direction, the direction and length of the arrow in the work icon may be modified so as to match with the actual gaze direction of the worker as shown in FIG. 10.

Further, in carrying out the present invention, when the selection for modification of the direction and length of the arrow is completed by the worker (i.e., when a finger is removed from the screen of the worker terminal after dragging), the worker terminal 100 may also activate a camera module equipped itself to induce photography of an inspection target area (for example, a wall) in the gaze direction of the worker (S130).

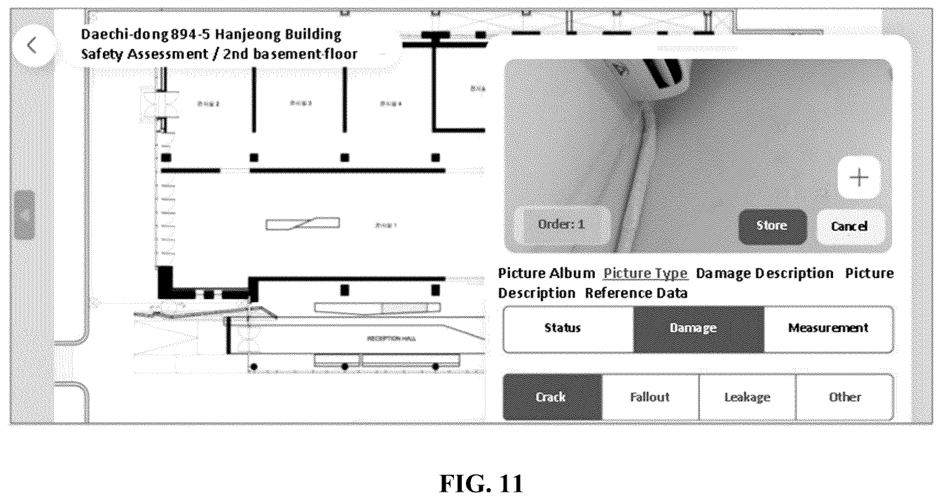

Thereby, when the worker takes a picture of the inspection target area in his/her gaze direction, the worker terminal 100 may store the photographed picture in the corresponding work icon in association therewith as shown in FIG. 11 (S140).

Meanwhile, in carrying out the present invention, the worker may also input by selecting primary classification information (for example, status, damage, measurement) of the photographed picture, and input by selecting secondarily detailed classification information from the selected primary classification information as shown in FIG. (S150).

In other words, when selecting ‘Status’ as the primary classification information for the photographed picture, it is possible to select the secondary classification information in detail from ‘Exterior View’ and ‘Interior View’, and when selecting ‘Damage’ as the primary classification information for the photographed picture, it is possible to select the secondary classification information in detail from ‘Crack’, ‘Fallout’, ‘Leakage’ and ‘Other’.

Further, in carrying out the present invention, when selecting ‘Crack’ as the secondary classification information, it is also possible to select tertiary classification information in detail from ‘Crack’ and ‘Separation’, and when selecting ‘Fallout’ as the secondary classification information, it is also possible to select the tertiary classification information in detail from ‘Peeling/Falling’, ‘Cross-sectional Defect’, ‘Reinforcing Bar Exposure/Corrosion’ and ‘Finishing Material Fallout’. In addition, when selecting ‘Leakage’ as the secondary classification information, it is also possible to select the tertiary classification information in detail from ‘Leakage’ and ‘Leakage Trace’.

Meanwhile, the worker terminal 100 may also output a request for the worker to input an additional description item, which is determined according to the classification information input by the worker as described above, on the screen of the worker terminal 100.

For example, when the primary classification information input by the worker for the photographed picture is ‘Damage’, the secondary classification information is ‘Crack’, and the tertiary classification information is also ‘Crack’, the worker terminal 100 sequentially outputs: ‘Request to Input Member Name’ for requesting a selection of any one of slab, beam, column, wall, masonry wall, ceiling, floor; ‘Crack Type Input Request’ for requesting a selection of any one of vertical, horizontal, diagonal, bending, shearing, diagonal tension, net-shaped, plastering, finishing material, heterogeneous material, joint; and ‘Crack Specification Input Request’, thereby allowing the worker to input the relevant additional description information required in association with the classification information input by the worker.

To this end, it is preferable to store a request for inputting the additional description item to be output according to the classification information selected by the worker as described above in the worker terminal 100, in association with each of the primary, secondary and tertiary classification information.

Meanwhile, the worker terminal 100 may store work information related to the photographed picture, which includes the classification information and the additional description information input by the worker, in association with the corresponding work icon.

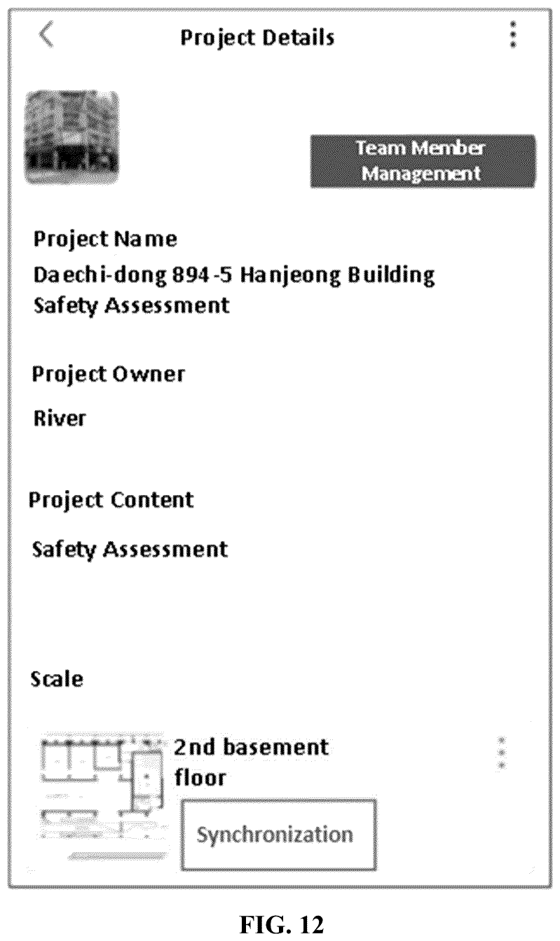

Thereafter, when the worker selects the ‘Synchronization’ button displayed in the work region of the corresponding floor as shown in FIG. 12, the work regions for each floor selected by the worker, the drawing images for each floor stored in association therewith, the work icons stored in association with the corresponding drawing images, the photographed pictures and the work information stored in association with the work icons may be uploaded to the management server 200.

As described above, the uploaded work regions for each floor to the management server 200, and the uploaded drawings for each floor and the work information, which are included and uploaded therein together, may be downloaded to the terminal 300 of the collaborator who is authorized to participate in the corresponding project, thus to support the performance of joint work between the worker and the collaborator on the corresponding floor.

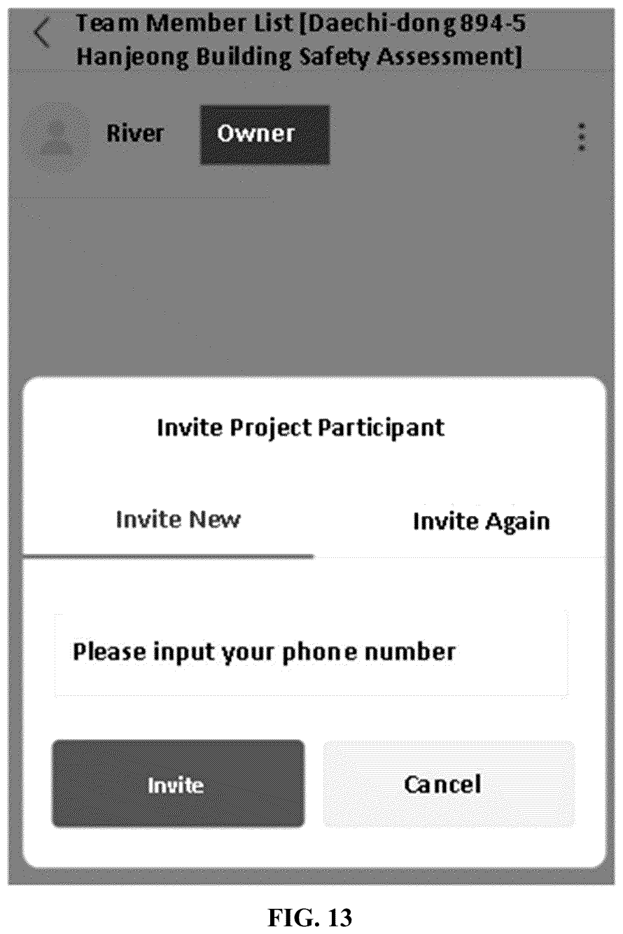

Specifically, when the worker selects a ‘Team Member Management’ item shown in FIG. 12 and inputs a phone number of a participant as shown in FIG. 13, the worker terminal 100 may generate a participant invitation message for inviting a project participant, and transmit it to the management server 200.

Accordingly, the management server 200 may transmit an invitation acceptance request message including link information capable of downloading the application program according to the present invention to the terminal 300, such as a smart phone of the participant, based on the participant's phone number included in the invitation message.

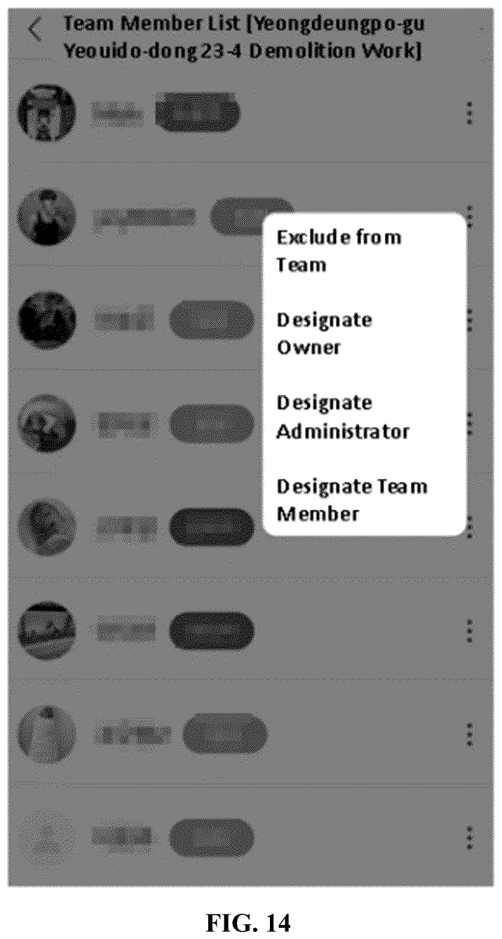

When a collaborator invited to participate in the project accepts the invitation, the collaborator may access the information uploaded to the management server 200 through his or her terminal 300 as described above. As a result, the worker may manage a list of all collaborators (team member list) who decided to participate in the project as shown in FIG. 14 (S160).

Specifically, the worker who generated the corresponding project has authority as an ‘Owner’. Then, the ‘Owner’ of such the project may freely select authority of each collaborator (′Exclude From Team′, ‘Designate Owner’, ‘Designate Manager’, or ‘Designate Team Member’ item), and the worker terminal 100 may individually set the authority of each collaborator according to selection information of the owner for the authority of each collaborator.

As described above, a plurality of collaborators who participate in the corresponding project independently execute safety assessment works such as those in steps S130 to S150 described above through the terminal 300 such as their smartphones, and the same upload procedure as the upload procedure to the management server 200 in the worker terminal 100 as described above is independently executed in each collaborator terminal 300, such that update of the drawings for each floor according to the simultaneous work of the plurality of collaborators is performed in real time by the management server 200 (S170).

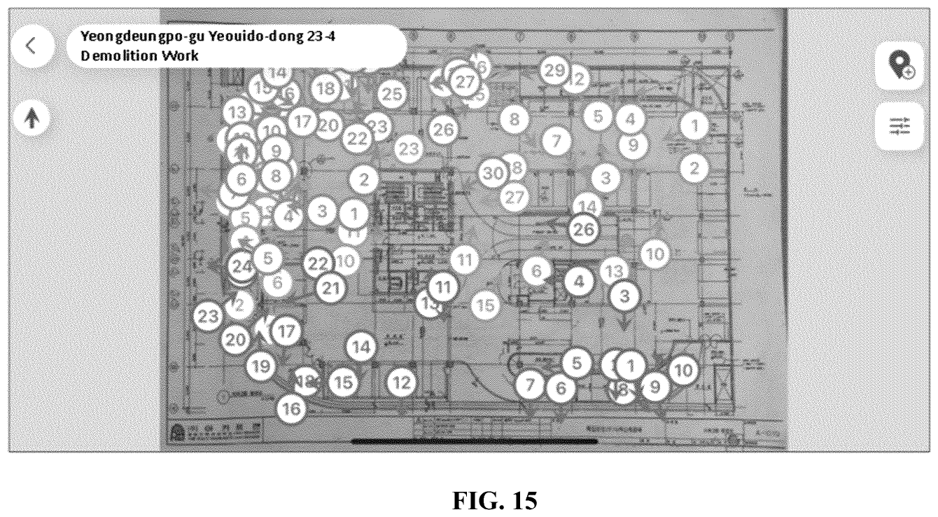

Accordingly, the management server 200 sequentially assigns the number of work icons according to an upload sequence of each work icon on the drawings for each floor as shown in FIG. 15, and assigns color information, which is individually assigned to each work so as to identify each worker, to the corresponding work icon.

As described above, the respective workers who might become available to receive and check the drawings for each floor including a plurality of work icons comprehensively updated by the management server 200 through their terminals 100 and 300 may request for the worker terminal 100 to perform filtering processing so as to select the work icons displayed on the screens of the terminals 100 and 300, by touching the icon filtering selection item ( [symbol] ) shown in 15 (S180).

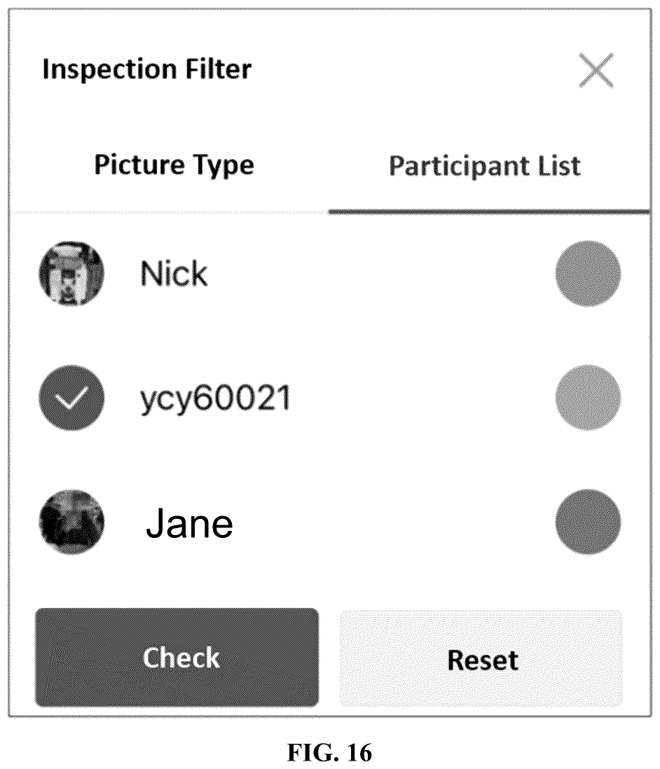

Specifically, when touching the icon filtering selection item ( [symbol] ) shown in FIG. 15, the filter selection item displayed as shown in FIG. 16 is largely divided into a picture classification (picture type) information selection item and a participant list selection item.

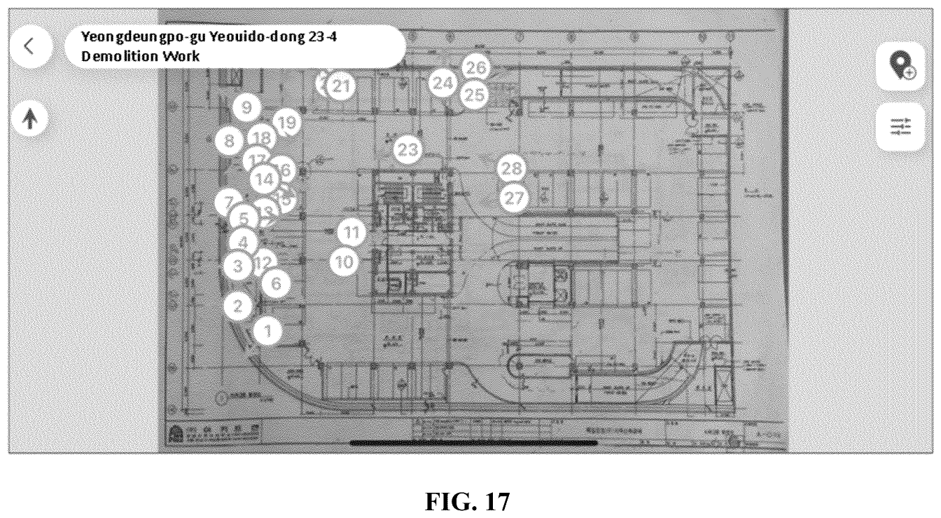

Thereby, when the worker selects the participant list selection item and then selects a specific participant as the filtering reference information, the worker terminal 100 selects only the work icons uploaded by the selected participants and outputs them as shown in FIG. 17. Accordingly, the worker may check the photographed pictures and related work information of the participants selected by him or her, by touching and selecting the corresponding work icons.

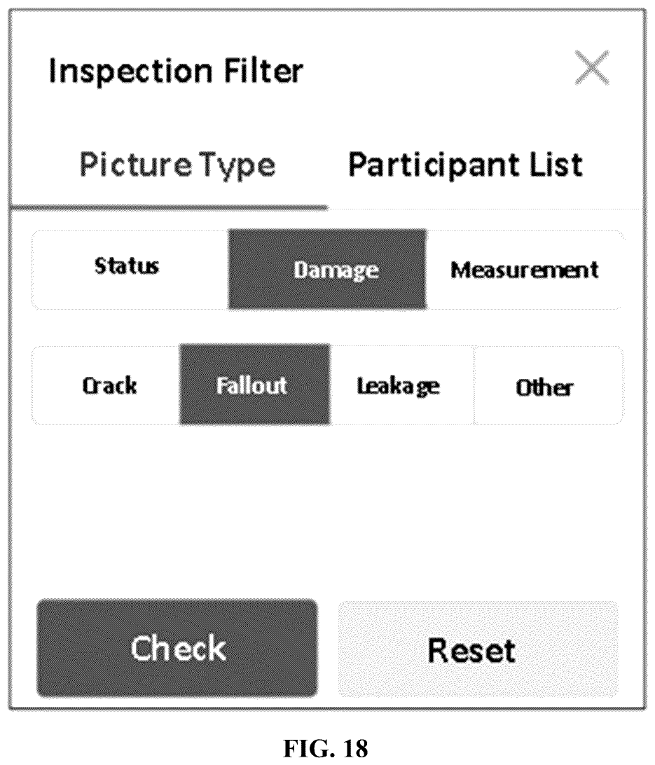

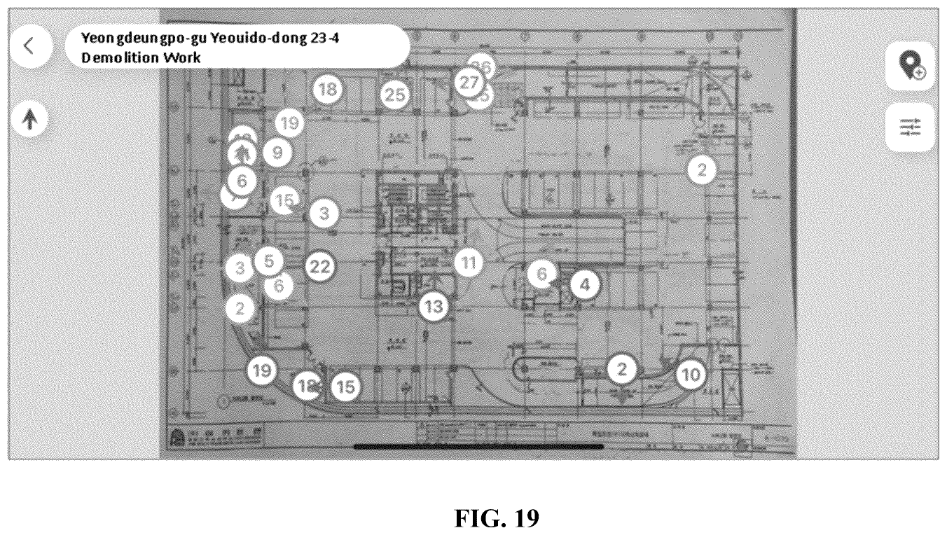

In addition, as shown in FIG. 18, when the worker selects the picture classification (picture type) information selection item in the filter selection item and then selects the primary, secondary and tertiary classification information (for example, damage, fallout, etc.) as the filtering reference information, the worker terminal 100 selects only the work icons in which the classification information matching the classification information selected by the worker is stored as work information in association therewith and outputs them as shown in FIG. 19. Accordingly, the worker may check the photographed pictures and related work information that match the classification information selected by him or her, by touching and selecting the corresponding work icons.

Meanwhile, in carrying out the present invention, the worker selects a specific participant as first filtering reference information in the participant list selection item and also selects the primary, secondary and tertiary classification information as second filtering reference information in the picture classification (picture type) information selection item. In this case, the worker terminal 100 may select and output only work icons that satisfy both the first filtering reference information and the second filtering reference information.

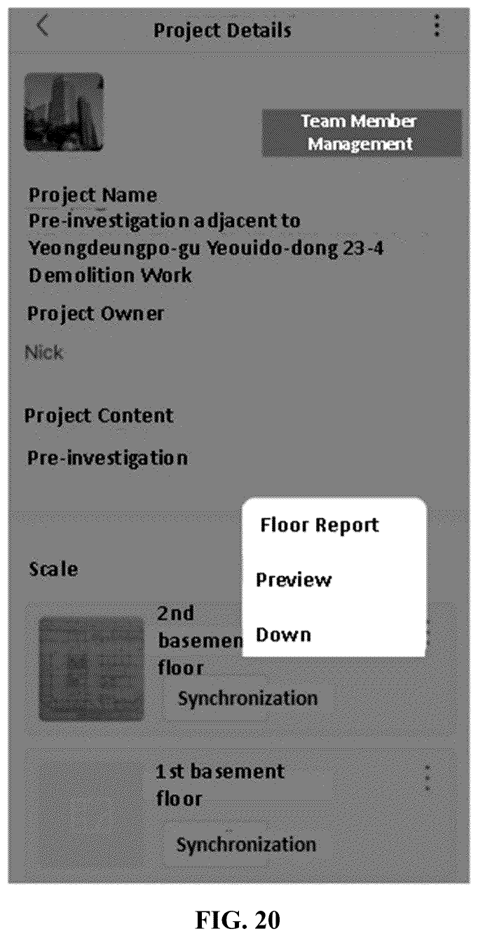

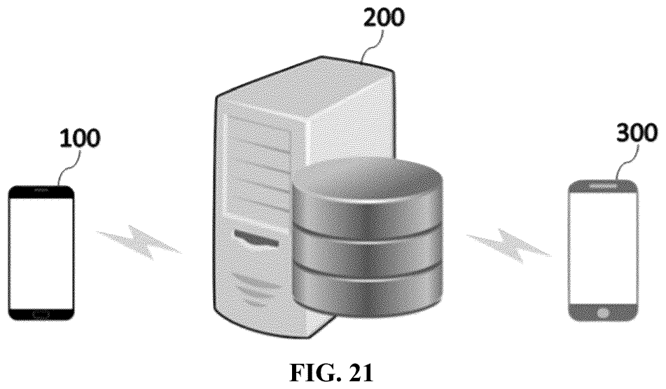

Further, in carrying out the present invention, the worker may select work regions for each floor as shown in FIG. 20, and then change the mutual position of the work regions for each floor upward or downward.

Further, in carrying out the present invention, when the worker selects the work regions for each floor and then selects ‘Floor Report Preview’ as shown in FIG. 20, the worker terminal 100 may also generate a safety assessment report for each floor, which includes work icon generation position information in the drawing of the corresponding floor, photographed pictures stored in association with each work icon, and the work information related thereto.

Further, in carrying out the present invention, the worker may select a drawing ‘Horizontal View’ mode and a drawing ‘Vertical View’ mode by inputting setting information of the application program. According to this setting information, the worker terminal 100 may also support drawing visibility according to the worker's selection by selectively executing the drawing horizontal view mode or the drawing vertical view mode as shown in FIGS. 7 to 11.

Furthermore, in carrying out the present invention, the application program has a function of backing up the safety assessment report and all information input or generated during the safety assessment process as described above to a storage device such as a PC or server designated by the worker. Thereby, it is preferable to be able to collectively submit backup data to a supervisory agency in order to assess the qualifications for a company to which the worker belongs in the future.

Furthermore, in carrying out the present invention, a program for executing the method for managing a safety assessment work of a building according to the present invention may be installed in the worker terminal 100 according to the present invention, recorded on various computer-readable recording media, or stored in the server that transmits the corresponding program through a network.

In addition, the program according to the present invention may be distributed in a computer system connected through a network, and computer-readable code may be stored and executed in a distributed manner. Further, functional programs, codes, and code segments for implementing the present invention will be easily understood by those skilled in the art to which the present invention pertains.

Terms used in the present invention are used only to describe specific embodiments, and are not intended to limit the present invention. Singular expressions used herein include plural expressions unless they have definitely opposite meanings in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

While the present invention has been described with reference to the preferred embodiments and modified examples, the present invention is not limited to the above-described specific embodiments and the modified examples, and it will be understood by those skilled in the art that various modifications and variations may be made therein without departing from the scope of the present invention as defined by the appended claims, as well as these modifications and variations should not be understood separately from the technical idea and prospect of the present invention.

Meanwhile, the sequence between the above-described steps (S110 to S180) in the present invention is only an example and is not limited thereto. That is, the sequence between the above-described steps (S110 to S180) may be changed, and some steps of them may be executed simultaneously or deleted.

### DESCRIPTION OF REFERENCE NUMERALS

100: Worker terminal
200: Management server
300: Collaborator terminal

What is claimed is:

1. A method for managing a safety assessment work of a building, comprising:
(a) receiving, by a worker terminal, floor number information of a safety assessment target building;
(b) generating, by the worker terminal, work regions for each floor for safety assessment collaboration between a plurality of workers based on the floor number information of the safety assessment target building;
(c) individually storing, by the worker terminal, drawings for each floor of the safety assessment target building in the work regions for each floor;
(d) receiving, by the worker terminal, primary classification information selected by the worker for photographed picture and secondary classification information, which is selectable classification information in detail according to the primary classification information;
(e) outputting, by the worker terminal, an input request for an additional description item determined based on the primary classification information and the secondary classification information;
(f) generating, by the worker terminal, a participant invitation message based on a phone number of a participant input by the worker;
(g) transmitting, by the worker terminal, the participant invitation message to a management server so that the management server transmits an invitation acceptance request message to a participant terminal based on the phone number of the participant;
(h) receiving, by the worker terminal, setting information about permissions of the participant; and
(i) receiving, by the worker terminal, filter selection item information of the worker, which includes each selection information for the primary classification information and the secondary classification information and participant selection information, as the filter selection item information for selection of work icons generated according to the safety assessment work of the worker and the participant.

2. The method for managing a safety assessment work of a building according to claim 1, further comprising
(j) selecting and outputting, by the worker terminal, work icons that satisfy both first filtering reference information including the participant selection information and second filtering reference information including each selection information for the primary classification information and the secondary classification information.

3. The method for managing a safety assessment work of a building according to claim 1, further comprising:
after step (c) and before step (d),
uploading, by the worker terminal, the work regions for each floor in which the drawings for each floor are stored to the management server;
generating, by the worker terminal, the work icon at a position selected by the worker on the drawings for each floor; and
activating, by the worker terminal, a camera module provided in the worker terminal when an indicating direction of the generated work icon is selected by the worker.

4. A worker terminal comprising a program installed therein to execute the method for managing a safety assessment work of a building according to any one of claim 1.
